(19) United States
(12) Patent Application Publication
(10) Pub. No.: US 2009/0230162 A1
(43) Pub. Date: Sep. 17, 2009

(54) FOLDABLE BICYCLE RACK

(76) Inventor: CHIU-KUEI WANG, Dajia Town (TW)

Correspondence Address: PHILLIP LIU, 6980, WHITEOAK DRIVE, RICHMOND, V7E4Z9, omitted

(21) Appl. No.: 12/241,022

(22) Filed: Sep. 29, 2008

(30) Foreign Application Priority Data
Mar. 11, 2008 (TW) 097108522

(51) Int. Cl. B60R 9/10

(52) U.S. Cl. 224/519

(57) ABSTRACT

A foldable bicycle rack includes a rack unit including multiple locking units for securing wheels of the bicycles and a holding bar for securing top tubes of the bicycles. The rack unit is pivotably connected to a support unit which is connected with rear end of a vehicle. The rack unit and the support unit are connected by a top piece on the rack unit and a bottom piece on the support unit, the top piece can be bottom separated from the bottom piece. The rack unit is pivotably connected to the support unit when not in use. A tilt unit is connected between the rack unit and the support unit so as to tilt the rack unit relative to the support unit to open the back hatch of the vehicle.

### FIELD OF THE INVENTION

The present invention relates to a bicycle rack attached to rear end of vehicles and the bicycle rack can be foldable to reduce space occupied when not in use.

### BACKGROUND OF THE INVENTION

A conventional bicycle rack attached to rear end of a vehicle is shown in FIG. 9 and generally includes a base part 41 connected to a tube which is connected to rear end of a vehicle, and two side tubes 44 each have a first end 441 and pivotably connected to the base part 41 by pins 46 and two rings 45 are connected to a second end of each of the two side tubes 44 so that wheels of the bicycle (not shown) on the bicycle rack are positioned by the rings 45. A post 42 has a first end 421 connected to the base part 41 and a second of the post 42 include two positioning members 43 connected thereto by a locking member 431. Each positioning member 43 has a hook so as to hook the top tube of a bicycle. The locking member 431 allows the positioning members 43 to be set at desired position on the post 42.

However, the conventional bicycle rack occupies too much space and the post 42 is located such that the back hatch of the vehicle cannot be opened.

The present invention intends to provide a foldable bicycle rack which can be tilted to allow the back hatch to be opened while the bicycle rack is still connected to the rear end of the vehicle.

### SUMMARY OF THE INVENTION

The present invention relates to a foldable bicycle rack which comprises a rack unit and a support unit which is connected with rear end of a vehicle. The support unit includes a U-shaped member which is pivotably connected to an L-shaped tube by a connection part. A bottom piece is connected to a first end of the L-shaped tube and a top piece is connected to the first end of the rack unit, the top piece is connected to the bottom piece by a pin. The second end of the rack unit is pivotably connected to a distal end of the support unit.

The primary object of the present invention is to provide a foldable bicycle rack connected to rear end of a vehicle and the bicycle rack can be folded to reduce space occupied by the bicycle rack.

Another object of the present invention is to provide a foldable bicycle rack wherein the rack unit can be tilted an angle to allow the back hatch of the vehicle to be opened without removing the bicycle rack from the vehicle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the foldable bicycle rack of the present invention;

FIG. 2 is an exploded view to show the foldable bicycle rack of the present invention;

FIG. 3 is a partial cross sectional view of the connected to the L-shaped tube and the U-shaped member 21 of the foldable bicycle rack of the present invention;

FIG. 3-1 is a cross sectional view taken along line a-a in FIG. 3;

FIG. 4 is a perspective view to show the connection of the guide plate and the U-shaped member of the support unit of the foldable bicycle rack of the present invention;

FIG. 4-1 is a cross sectional view taken along line a-a in FIG. 4;

FIG. 5 is an exploded view to show the holding bar and the locking unit of the foldable bicycle rack of the present invention;

FIG. 6 shows that a bicycle is secured on the foldable bicycle rack of the present invention;

FIG. 7 shows the folded status of the foldable bicycle rack of the present invention;

FIG. 8 shows that the rack unit is tilted an angle relative to the L-shaped tube, and

FIG. 9 is a perspective view to show a conventional bicycle rack.

### DETAILED DESCRIPTION OF THE PREFERRED EMBODIMENT

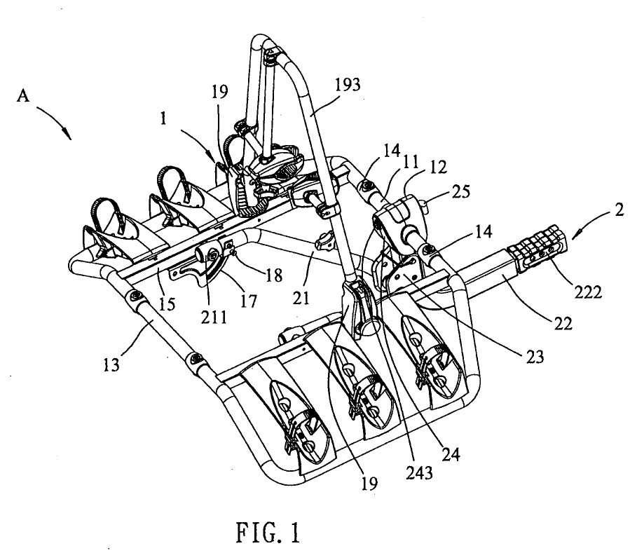

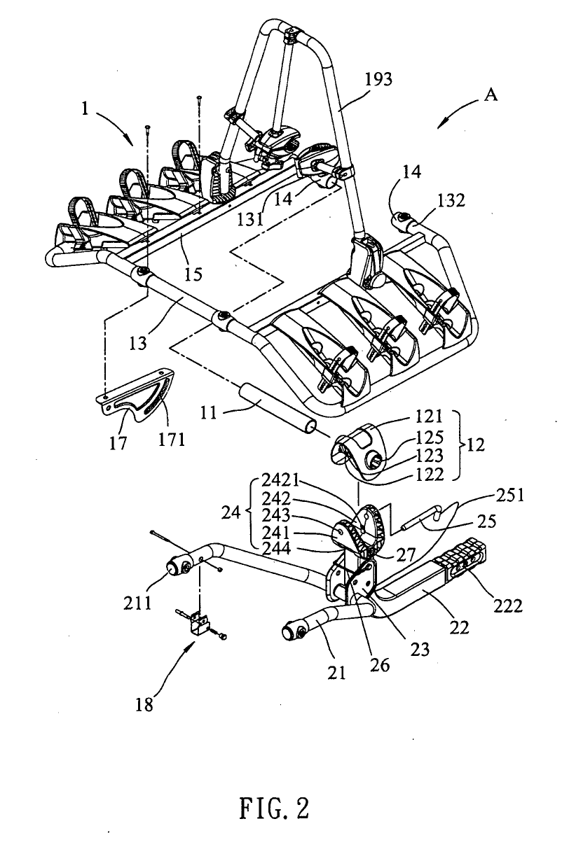

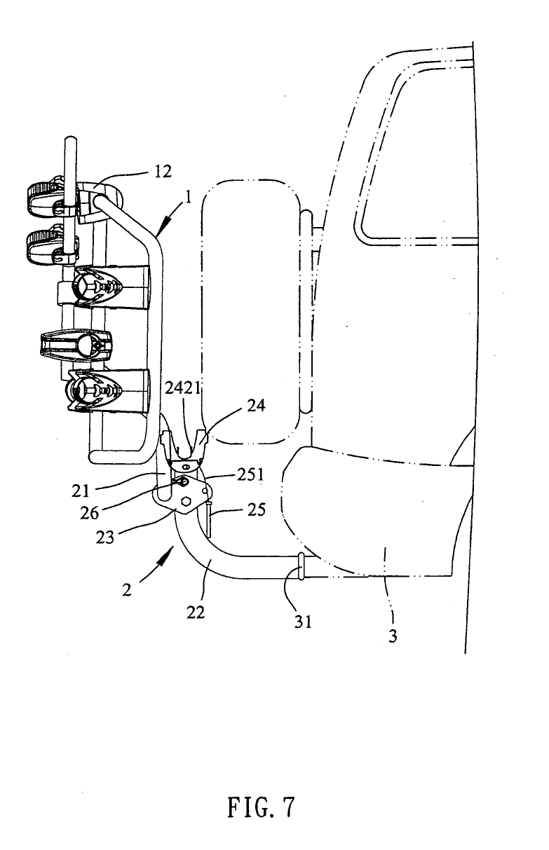

Referring to FIGS. 1 and 2, the foldable bicycle rack “A” of the present invention comprises a rack unit 1 and a support unit 2 which is connected with rear end 3 of a vehicle as shown in FIG. 7. The support unit 2 includes a U-shaped member 21 which is pivotably connected to an L-shaped tube 22 by a connection part 23. The L-shaped tube 22 has a bottom piece 24 connected to a first end thereof and an insertion portion 222 is connected to a second end of the L-shaped tube 22. The insertion portion 222 is inserted into a reception hole 31 at the rear end 3 of the vehicle as shown in FIG. 7. The bottom piece 24 is a U-shaped body 241 which includes a reception space 242 and a clamp member 2421 is located in the reception space 242 and two holes 243 are defined through the U-shaped body 241. A positioning slot 244 is defined in an underside of the U-shaped body 241 and the L-shaped tube 22 is engaged with the positioning slot 244. The L-shaped tube 22 has an oval hole 223 so that the bolt 27 extends through the oval hole 223 and the bottom piece 24. A convex 245 is located within the positioning slot 244 and is engaged with a hollow interior 221 of the L-shaped tube 22 to easily position the bottom piece 24 to the L-shaped tube 22 when assembly.

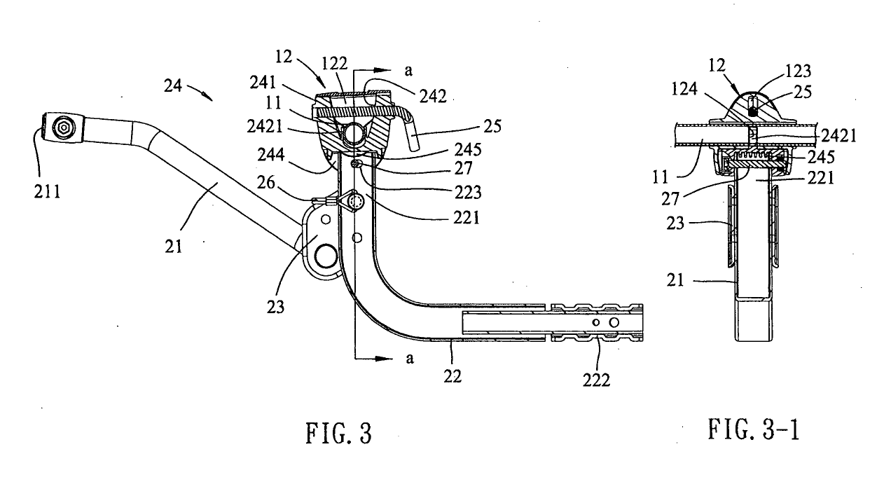

Further referring to FIGS. 3 and 3-1, the rack unit 1 generally is a rectangular frame and includes a first end and a second end, wherein a tube 13 is bent to be a U-shaped frame and a part of the tube 13 forms the second end of the rack unit 1. A first end 131 and a second end 132 of the tube 13 are separated at a distance. A bar 11 has two ends thereof connected to two connection sleeves 14 on the first and second ends 131, 132 of the tube 13. A top piece 12 is connected to the bar 11 of the first end of the rack unit and the top piece 12 includes an inverted U-frame 121. A protrusion 122 is connected to an inside of the inverted U-frame 121. The protrusion 122 is engaged with the reception space 242 of the U-shaped body 241 and a notch 124 is defined in the protrusion 122 and the clamp member 2421 clamps the bar 11 via the notch 124. The protrusion 122 includes a passage 123 through which the bar 11 extends. The pin 25 extends through the holes 243 of the bottom piece 24 and the passage 123 of the top piece 12 to connect the rack unit 1 to the support unit 2. By this arrangement, the second end of the rack unit 1 is pivotably connected to a distal end 211 of the support unit 2. The pin 25 is an L-shaped pin and connected with a rope 251 which ties the pin 25 to the L-shaped tube 22.

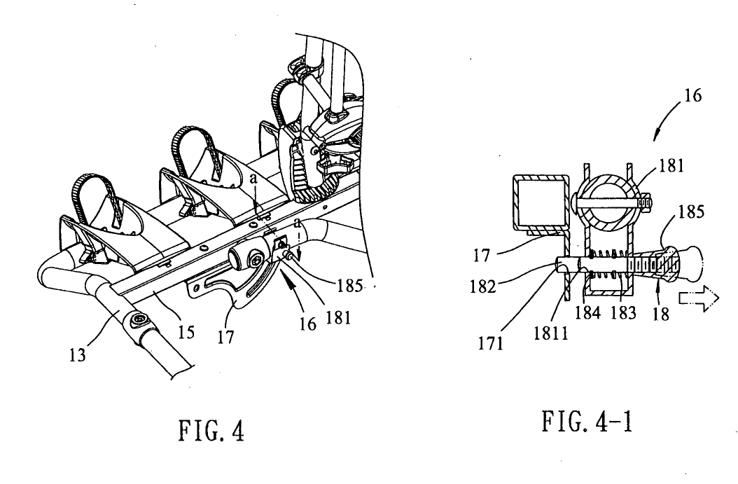

Referring to FIGS. 4 and 4-1, the rack unit 1 includes a tilt unit 16 which includes a guide plate 17 and a positioning rod 18, the guide plate 17 is connected to one of two rods 15 connected between the first and second ends of the rack unit 1. The guide plate 17 includes a curved slot 171 defined therethrough which includes a high end and a low end. The positioning rod 18 is connected to the U-shaped member 21 and slidably engaged with the curved slot 171 in the guide plate 17. The positioning rod 18 includes a U-plate 181 fixed to the distal end 211 of the U-shaped member 21 and two through holes 1811 are defined through the U-plate 181. A spring 183 and a clamp 184 are located between two sides of the U-plate and an axle 182 extends through the two through holes 1811, the spring 183 and the clamp 184. An end of the positioning rod 18 is connected with a handle 185 so that the positioning rod 18 can be pulled to compress the spring 183 by pulling the handle 185 so as to allow the rack unit 1 to be tilted along the curved slot 171.

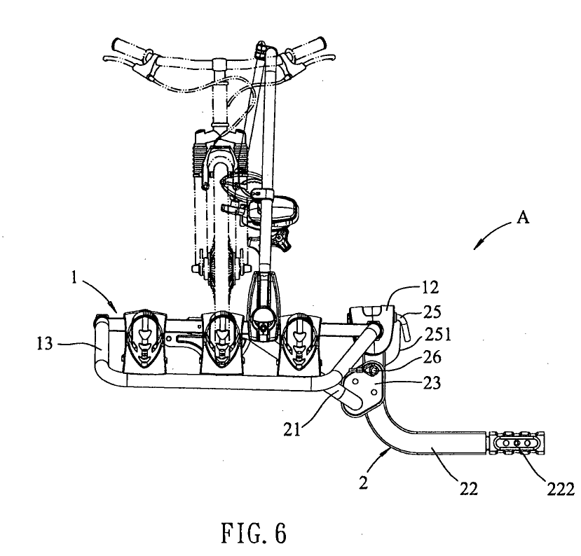

The rack unit 1 further includes a plurality of locking units 19 connected between the two sides and the two rods 15 parallel to the two sides of the rack unit 1. The two wheels of the bicycle that is carried by the bicycler rack “A” can be positioned by the locking units 19. A U-shaped holding bar 193 is connected between the two rods 15 of the rack unit 1 to hold the handlebar of the bicycle as shown in FIG. 6.

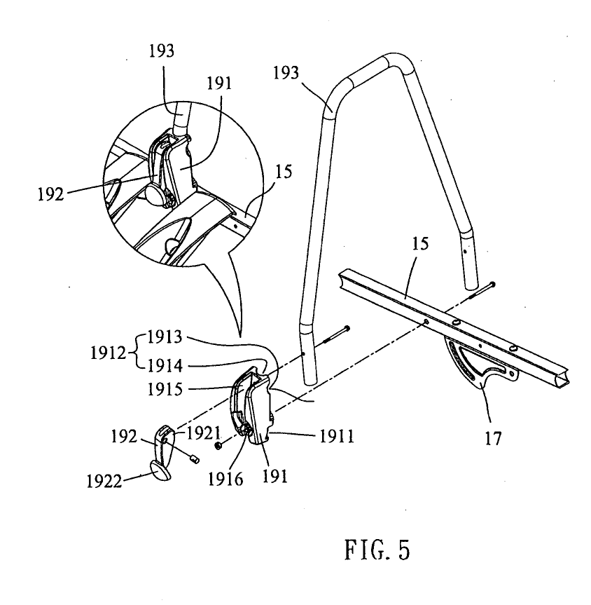

Referring to FIG. 5, each of the locking units 19 includes a body 191 which includes a rectangular slot 1911 in a first side thereof so that the rod 15 is engaged with the rectangular slot 1911. A positioning slot 1912 is defined in the first side of the body 191 and a distal end of the holding bar 193 is engaged with the positioning slot 1912. The positioning slot 192 is composed of a longitude slot 1913 and a latitude slot 1914 which communicates with the lever 192 longitude slot 1913. The longitude slot 1913 and the latitude slot 1914 decide the position of the holding bar 193 when distal end of the holding bar 193 is engaged with one of the longitude slot 1913 and the latitude slot 1914. A groove 1915 is defined in a second side of the body 191 and a lever 192 is pivotably connected to the groove 1915. The lever 192 includes a cam portion 1921 which is rotatably engaged with the groove 1915 and a pin extends through the distal end of the holding bar 193 and is connected to the cam portion 1921 so as to secure and control the distal end of the holding bar 193. The lever 192 has an operation plate 1922 and the groove 1915 communicates with an engaging notch 1916. The operation plate 1922 is engaged with the engaging notch 1916 and defines an access hole between the operation plate 1922 and the body 191, so that the user can insert his/her finger to lift the lever 192.

As shown in FIG. 6, the foldable bicycle rack “A” is connected to the rear end 3 of the vehicle by inserting the insertion portion 222 of the L-shaped tube 22 into the reception hole 31 in the rear end 3 of the vehicle. The rack unit 1 is then connected to the support unit 2 by connecting the top piece 12 and the bottom piece 24. The holding bar 193 is adjusted to upright position to hole the handlebar of the bicycle so that the bicycle does not shake.

As shown in FIG. 7, when the foldable bicycle rack “A” is not in use, the pin 25 is removed, the positioning rod 18 is pulled and the quick-release 26 is released, the rack unit 1 is rotated counter clockwise and the U-shaped member 21 is pivoted clockwise, the rack unit 1 can be pivoted to upright position. The holding bar 193 is then positioned to horizontal position. The locking units 19 are released and the holding bar 193 is removed from the longitude slot 1913 and engaged with the latitude slot 1914. The locking units 19 are then locked again. The rack unit 1 can be easily connected to or removed from the support unit 2. The rack unit 1 and the U-shaped member 21 can be positioned upright when not in use so that the space occupied can be reduced.

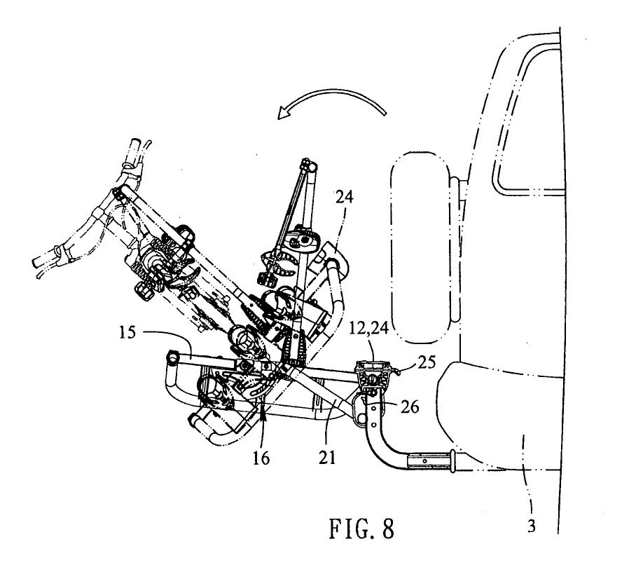

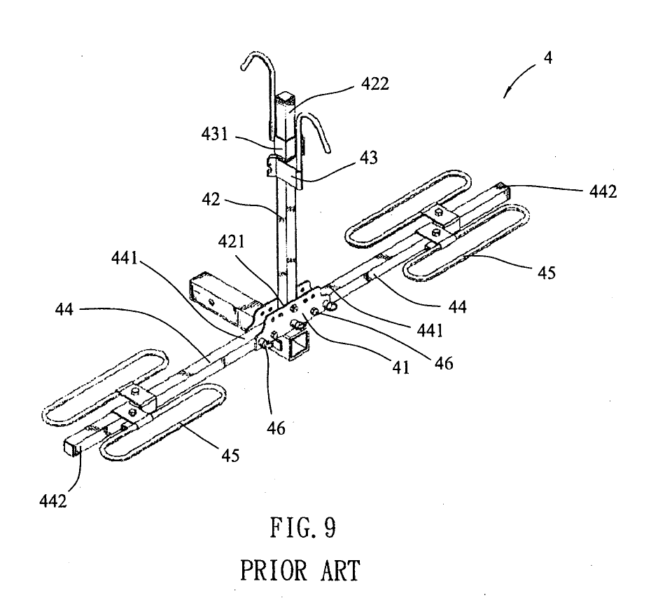

As shown in FIG. 8, when opening the back hatch, the pin 25 is removed and the quick-release 26 is unlocked, the bottom piece 24 and the top piece 12 is separated. Because of the gravity applied to the rack unit 1, the rod 15 and the U-shaped member 21 are tilted along the curved slot 171, the rack unit 1 is pivoted about the pivot point with the U-shaped member 21. By this way, the back hatch can be opened without removing the whole bicycle rack “A” from the vehicle.

While we have shown and described the embodiment in accordance with the present invention, it should be clear to those skilled in the art that further embodiments may be made without departing from the scope of the present invention.

What is claimed is:

1. A foldable bicycle rack (A) comprising:
a rack unit (1) and a support unit (2) which is adapted to be connected with rear end (3) of a vehicle, the support unit (2) including a U-shaped member (21) which is pivotably connected to an L-shaped tube (22) by a connection part (23), a bottom piece (24) connected to a first end of the L-shaped tube (22) and the rack unit (1) having a top piece (12) on a first end thereof, the top piece (12) connected to the bottom piece (24) by a pin (25), a second end of the rack unit (1) pivotably connected to a distal end (211) of the support unit (2).

2. The bicycle rack as claimed in claim 1, wherein the bottom piece (24) is a U-shaped body (241) which includes a reception space (242), a clamp member (2421) is located in the reception space (242) and two holes (243) are defined through the U-shaped body (241) such that the pin (25) extends through the two holes (243), a positioning slot (244) is defined in an underside of the U-shaped body (241) and the L-shaped tube (22) is engaged with the positioning slot (244).

3. The bicycle rack as claimed in claim 2, wherein a convex (245) is located within the positioning slot (244) and is engaged with a hollow interior (221) of the L-shaped tube (22).

4. The bicycle rack as claimed in claim 2, wherein a bolt (27) extends through the bottom piece (24) and the L-shaped tube (22).

5. The bicycle rack as claimed in claim 4, the L-shaped tube (22) has an oval hole (223) so that the bolt (27) extends through the oval hole (223).

6. The bicycle rack as claimed in claim 2, wherein the first end of the rack unit (1) includes a bar (11) to which the top piece (12) is connected, the top piece (12) includes an inverted U-frame (121) and a protrusion (122) is connected to an inside of the inverted U-frame (121), the protrusion (122) is engaged with the reception space (242) of the U-shaped body (241), a notch (124) is defined in the protrusion (122) and the clamp member (2421) clamps the bar (11) via the notch (124), the protrusion (122) includes a passage (123) through which the bar (11) extends.

7. The bicycle rack as claimed in claim 6, wherein the rack unit (1) includes a tube (13) which is bent to be a U-shaped frame and a part of the tube (13) forms the second end of the rack unit (1), a first end (131) and a second end (132) of the tube (13) are separated at a distance, the bar (11) has two ends thereof connected to two connection sleeves (14) on the first and second ends (131, 132) of the tube (13).

8. The bicycle rack as claimed in claim 7, wherein the pin (25) extends through the holes (243) of the bottom piece (24) and the passage (123) of the top piece (12) to connect the rack unit (1) to the support unit (2).

9. The bicycle rack as claimed in claim 8, wherein the pin (25) is an L-shaped pin.

10. The bicycle rack as claimed in claim 9, wherein the pin (25) is connected with a rope (251) which ties the pin (25) to the L-shaped tube (22).

11. The bicycle rack as claimed in claim 1, wherein the rack unit (1) includes a tilt unit (16) which includes a guide plate (17) and a positioning rod (18), the guide plate (17) is connected to one of two rods (15) connected between the first and second ends of the rack unit (1), the positioning rod (18) is connected to the U-shaped member (21) and slidably engaged with a curved slot (171) in the guide plate (17).

12. The bicycle rack as claimed in claim 11, wherein the curved slot (171) includes a high end and a low end.

13. The bicycle rack as claimed in claim 11, wherein the positioning rod (18) includes a U-plate (181) fixed to the distal end (211) of the U-shaped member (21) and two through holes (1811) are defined through the U-plate (181), a spring (183) and a clamp (184) are located between two sides of the U-plate and an axle (182) extends through the two through holes (1811), the spring (183) and the clamp (184), an end of the positioning rod (18) is connected with a handle (185), the positioning rod (18) is pulled to compress the spring (183) by pulling the handle (185).

14. The bicycle rack as claimed in claim 11, wherein the rack unit (1) includes a plurality of locking units (19) connected between the two sides and the two rods (15) parallel to the two sides of the rack unit (1), a holding bar (193) is connected between the two rods (15) of the rack unit (1).

15. The bicycle rack as claimed in claim 14, wherein each of the locking units (19) includes a body (191) which includes a rectangular slot (1911) in a first side thereof so that the rod (15) is engaged with the rectangular slot (1911), a positioning slot (1912) is defined in the first side of the body (191) and a distal end of the holding bar (193) is engaged with the positioning slot (1912), a groove (1915) is defined in a second side of the body (191) and a lever (192) is pivotably connected to the groove (1915), the lever (192) includes a cam portion (1921) which is rotatably engaged with the groove (1915) and a pin extends through the distal end of the holding bar (193) and is connected to the cam portion (1921) so as to secure and control the distal end of the holding bar (193).

16. The bicycle rack as claimed in claim 15, wherein the lever (192) has an operation plate (1922) and the groove (1915) communicates with an engaging notch (1916), the operation plate (1922) is engaged with the engaging notch (1916) and defines an access hole between the operation plate (1922) and the body (191).

17. The bicycle rack as claimed in claim 15, wherein the positioning slot (192) is composed of a longitude slot (1913) and a latitude slot (1914) which communicates with the lever (192) longitude slot (1913).
